(19) United States
(12) Patent Application Publication
(10) Pub. No.: US 2013/0219023 A1
(43) Pub. Date: Aug. 22, 2013

(54) EMERGENCY ALERT SYSTEM NOTIFICATIONS VIA OVER-THE-TOP SERVICE

(71) Applicants: Vinod Krishnan Surianarayanan, Chennai (IN); Narendra Babu, Chennai (IN); Syed Mohasin Zaki, Chennai (IN); Saleem Mohammed, Chennai (IN); Vijay Senthil Angayarkanni, Chennai (IN)

(72) Inventors: Vinod Krishnan Surianarayanan, Chennai (IN); Narendra Babu, Chennai (IN); Syed Mohasin Zaki, Chennai (IN); Saleem Mohammed, Chennai (IN); Vijay Senthil Angayarkanni, Chennai (IN)

(73) Assignee: VERIZON PATENT AND LICENSING INC., Basking Ridge, NJ (US)

(21) Appl. No.: 13/401,880

(22) Filed: Feb. 22, 2012

(51) Int. Cl. G06F 15/16

(52) U.S. Cl. 709/219

(57) ABSTRACT

A device receives first streaming media from a content delivery server at a client device via an OTT network service. The device receives an Emergency Alert System (EAS) notification at the client device, and receives via the OTT network service and plays, subsequent to the EAS notification, EAS media at the client device. The device disables a user interface at the client device to prevent user interface interactions until completion of the playing of the EAS media.

### BACKGROUND

Over-the-top (OTT) services involve services that ride on top of an existing network service provided by a network operator, where the OTT services don't require any business or technology affiliations with the network operator. For example, televisions (TVs), Digital Video Disk (DVD) players and video game consoles are being built with wireless connectivity such that they can “piggyback” on an existing wireless network and pull content from the Internet. OTT services are likely to have a significant role in the proliferation of Internet television and Internet-connected TVs. OTT services may include audio, video, data, voice and other services.

The Emergency Alert System (EAS) is a national warning system used in the United States that alerts the public of emergencies, such as, for example, local weather emergencies. EAS is part of the Integrated Public Alert and Warning System (IPAWS) and is jointly coordinated by the Federal Emergency Management Agency (FEMA), the Federal Communications Commission (FCC), and the National Weather Service. The EAS is currently used over AM and FM radio, satellite radio, Land Mobile Radio Service, broadcast TV, and cable TV. During the occurrence of public emergencies, the EAS may be used to transmit emergency messages to the public to provide essential information about the emergencies. The emergency messages may include video or audio content.

### BRIEF DESCRIPTION OF THE DRAWINGS

FIG. 1 is a diagram that illustrates an overview of the delivery of EAS data in a network environment in which client devices receive streaming media via an OTT service;

FIG. 2A is a diagram that depicts an exemplary network environment in which EAS media is delivered to one or more OTT client devices via an OTT service;

FIG. 2B is a diagram that depicts further details of media delivery via the various nodes of the media delivery network of FIG. 2A;

FIG. 3 is a diagram that depicts exemplary components of the content delivery server of FIGS. 2A and 2B;

FIGS. 4A and 4B are diagrams that depict an exemplary embodiment in which an OTT client device is notified of EAS media delivery via a notification inserted into a Hypertext Transfer Protocol Live Streaming response message returned to the OTT client device in response to a Hypertext Transfer Protocol Live Streaming request message;

FIG. 5 is a flow diagram of an exemplary process associated with the exemplary embodiment of FIGS. 4A and 4B;

FIGS. 6A, 6B and 6C are diagrams that depict another exemplary embodiment in which OTT client devices poll an EAS server to check whether EAS has become active;

FIG. 7 is a flow diagram of an exemplary process associated with the exemplary embodiment of FIGS. 6A, 6B and 6C;

FIGS. 8A, 8B and 8C are diagrams that depict a further exemplary embodiment in which OTT client devices receive EAS notifications in Hypertext Transfer Protocol response messages received from a server in response to Hypertext Transfer Protocol request messages that request a resource from the server;

FIG. 9 is a flow diagram of an exemplary process associated with the exemplary embodiment of FIGS. 8A, 8B and 8C;

FIGS. 10A-10D depict an additional exemplary embodiment in which OTT client devices report whether or not they are currently receiving streaming media from a content delivery server, and EAS media is delivered to the OTT client devices either in a same stream as the currently streaming media, or in a different stream on a different channel, based on each device's report;

FIGS. 11A and 11B are flow diagrams of an exemplary process associated with the exemplary embodiment of FIGS. 10A-10D; and

FIG. 12 is a flow diagram of another exemplary process associated with the exemplary embodiment of FIGS. 10A-10D.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

Hypertext Transfer Protocol (HTTP) Live Streaming (HLS) is a HTTP-based media streaming communications protocol that involves breaking the media stream into a sequence of file downloads. Each file may be downloaded as one portion of a transport stream. Each downloaded file may be played in sequence to present a continuous media stream. As a given stream is played, the client may choose from multiple different alternative streams containing the same content encoded at various data rates. At the beginning of a streaming session, the client downloads a playlist file that specifies the different or alternate streams that are available.

In HLS, a given multimedia presentation is specified by a Uniform Resource Identifier (URI) to the playlist file, which itself includes an ordered list of media URIs and informational tags. Each media URI refers to a media file that is a segment of a single continuous media stream. To play a stream, a client first obtains the playlist file and then obtains and plays each media file in the playlist in sequence.

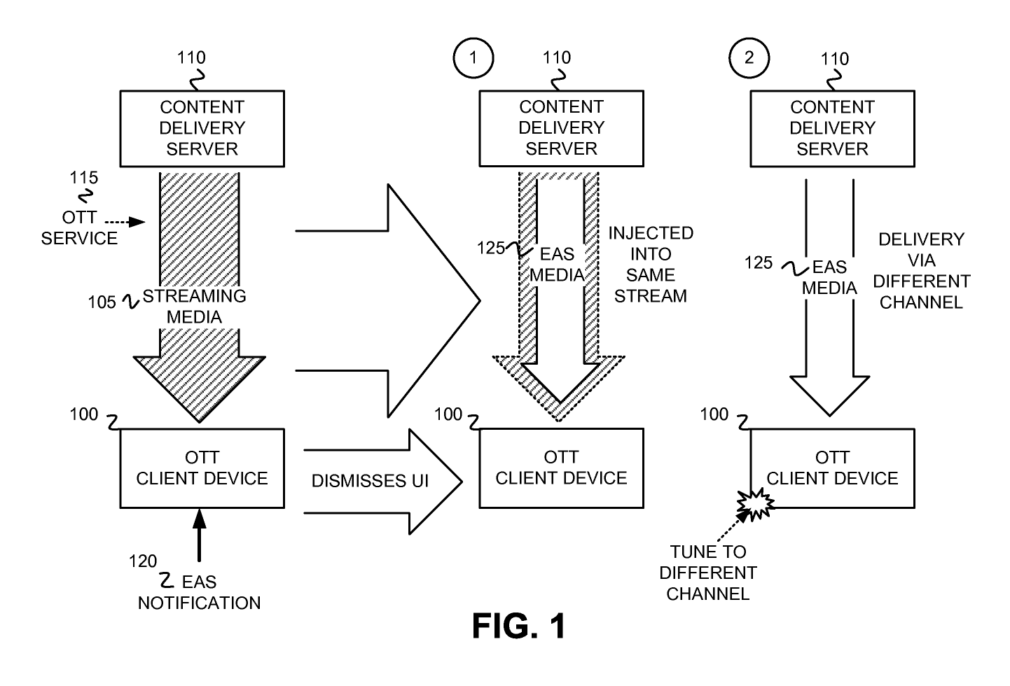

FIG. 1 illustrates an overview of the delivery of EAS data in a network environment in which client devices receive streaming media via an OTT service. An “Over-The-Top” service, as referred to herein, is a service, which is utilized over a network that is not offered by the network operator of that network. An OTT service, as referred to herein, is, thus, a service that rides on top of an existing network service and doesn't require any business or technology affiliations with the network operator. An “Emergency Alert System,” as referred to herein, is a warning system that alerts the public of emergencies, or of the occurrence of significant events, and provides essential information about those emergencies or events. An EAS may, for example, be implemented locally, regionally, or on a national scale, to provide public alerts. In the U.S., the EAS is part of the Integrated Public Alert and Warning System (IPAWS) that is jointly coordinated by the Federal Emergency Management Agency (FEMA), the Federal Communications Commission (FCC), and the National Weather Service. An EAS may be used over any type of communications technology available to the public, such as, for example, AM and/or FM radio, satellite radio, Land Mobile Radio Service, broadcast TV, and/or cable TV. An EAS may provide alert messages via audio, video and/or textual messages.

As shown in the overview of the delivery of EAS data in a network environment of FIG. 1, an OTT client device 100 may receive streaming media 105 from a content delivery server 110 via an OTT service 115. OTT client device 100 may include any type of network device that may receive media via an OTT service, such as, for example, a packet-switched OTT service. OTT client device 100 may include, for example, a computer (e.g., desktop, laptop, palmtop or tablet computer), a Personal Digital Assistant (PDA), a cellular telephone (e.g., a smart phone), or a Set-Top Box (STB). Streaming media 105 may include any type of media such as, for example, text, audio and/or video media. Streaming media 105 may be delivered using a media streaming communications protocol such as, for example, HLS.

As depicted in FIG. 1, an EAS notification 120 may be delivered to OTT client device 100 when EAS becomes active in the geographic region in which OTT client device 100 is located. For example, a natural disaster may occur in the region in which OTT client device 100 is located, and upon activation of EAS, EAS notification 120 may be sent to OTT client device 100. EAS notification 120 may serve as a notification to OTT client device 100 that EAS media is available to be delivered to OTT client device 100. In one embodiment (identified with a “1” within a circle in FIG. 1), EAS notification 120 may notify OTT client device 100 that content delivery server 110 may inject EAS media 125 into a same stream as media 105 currently being streamed between content delivery server 110 and OTT client device 100. When EAS media 125 has finished, content delivery server 110 may resume delivering streaming media 105 to OTT client device 100 via the same stream. During streaming of the EAS media from content delivery server 110 to OTT client device 100, OTT client device 100 may disable its user interface (UI) such that user control of the user interface is prevented or inhibited. OTT client device 100 may re-engage the UI when the EAS media has completed.

In another embodiment (identified with a “2” within a circle in FIG. 1), EAS notification 120 may notify OTT client device 100 to tune to a different channel than that is used to stream streaming media 105 from content delivery server 110 to OTT client device 100. Content delivery server 110 may deliver EAS media 125 to OTT client device 100 via the different channel. When EAS media 125 has finished, OTT client device 100 may re-tune to the original channel over which streaming media 105 was previously being delivered and may re-engage the UI, and content delivery server 110 may resume delivering streaming media 105.

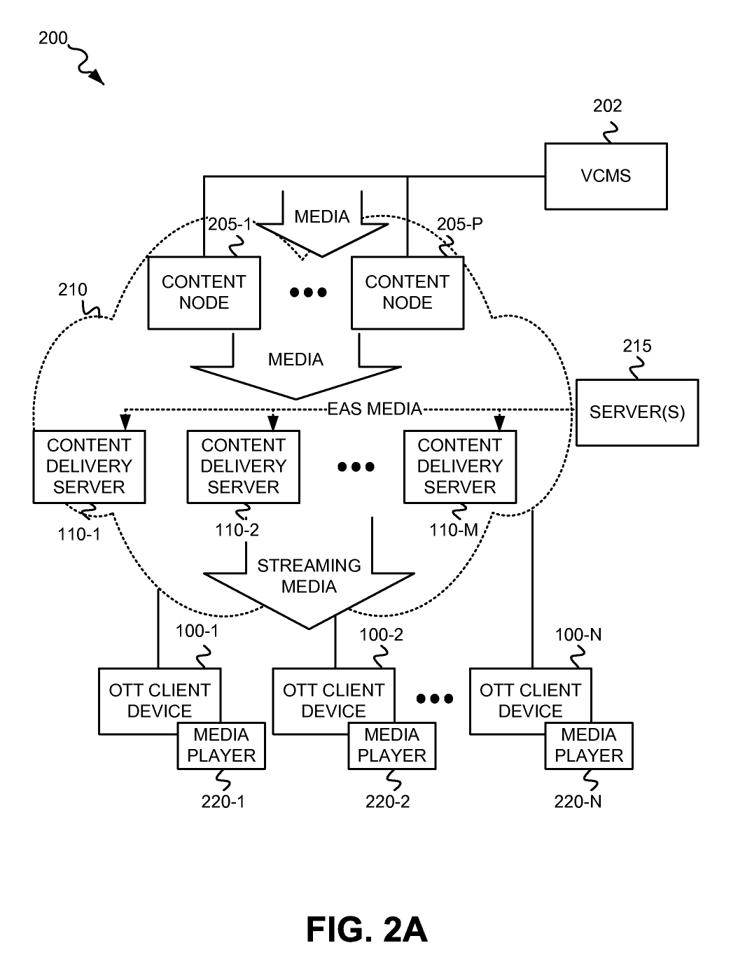

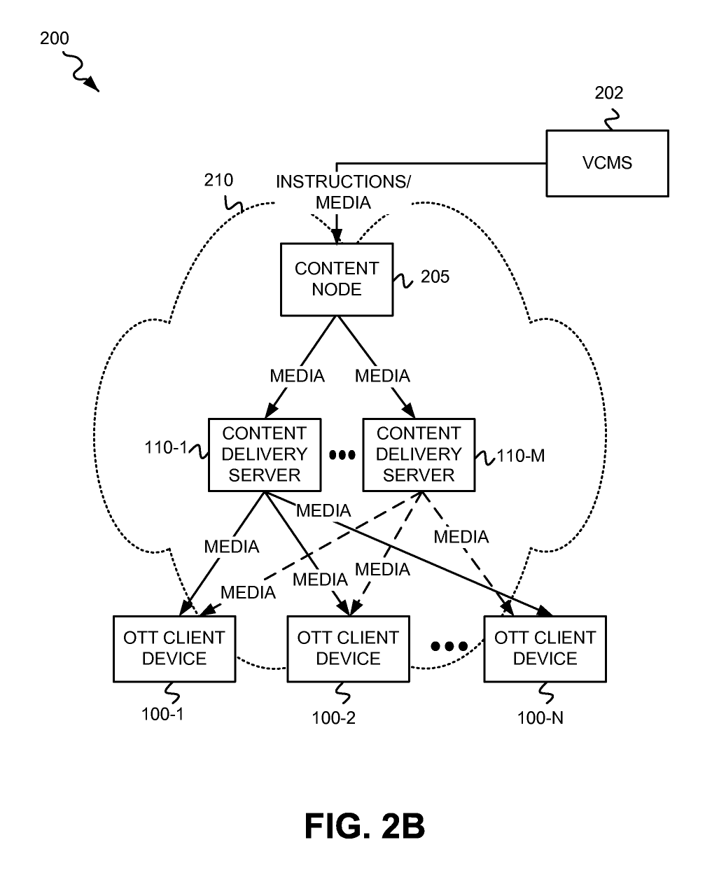

FIG. 2A depicts an exemplary network environment 200 in which EAS media is delivered to one or more OTT client devices via an OTT service. Network environment 200 may include a Virtual Central Management System (VCMS) 202, a media delivery network 210, a server(s) 215, and OTT client devices 100-1 through 100-N (generically and individually referred to herein as “OTT client device 100”).

VCMS 202 may include a system that manages the delivery of media via nodes of media delivery network 210 to OTT client devices 100-1 through 100-N. Media delivery network 210 may include multiple nodes for delivering media and/or other data to OTT client devices 100-1 through 100-N via an OTT service. As shown in FIG. 2A, media delivery network 210 may include content nodes 205-1 through 205-P (generically and individually referred to herein as “content node 205”) and content delivery servers 110-1 through 110-M (generically and individually referred to herein as “content delivery server 110”). Content nodes 205-1 through 205-P may include network nodes that distribute media to selected ones of content delivery servers 110-1 through 110-M based on management instructions from VCMS 202. Content delivery servers 110-1 through 110-M may include network nodes that receive media delivered from content nodes 205-1 through 205-P and/or server(s) 215, and deliver that media to selected ones of OTT client devices 100-1 through 100-N.

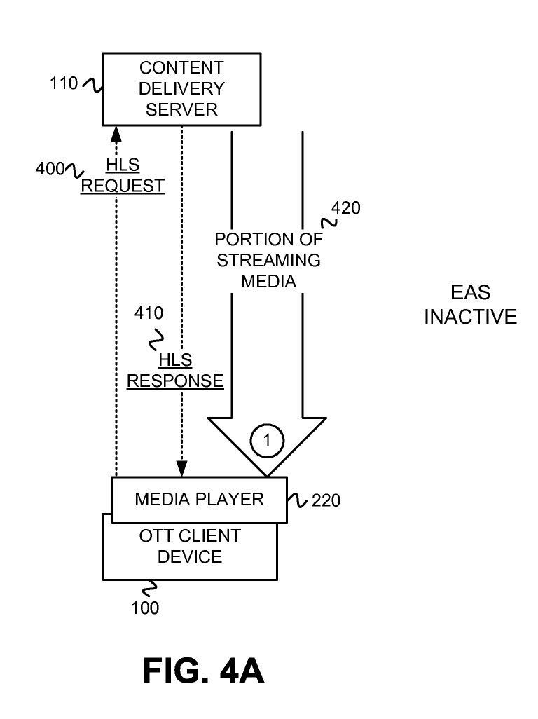

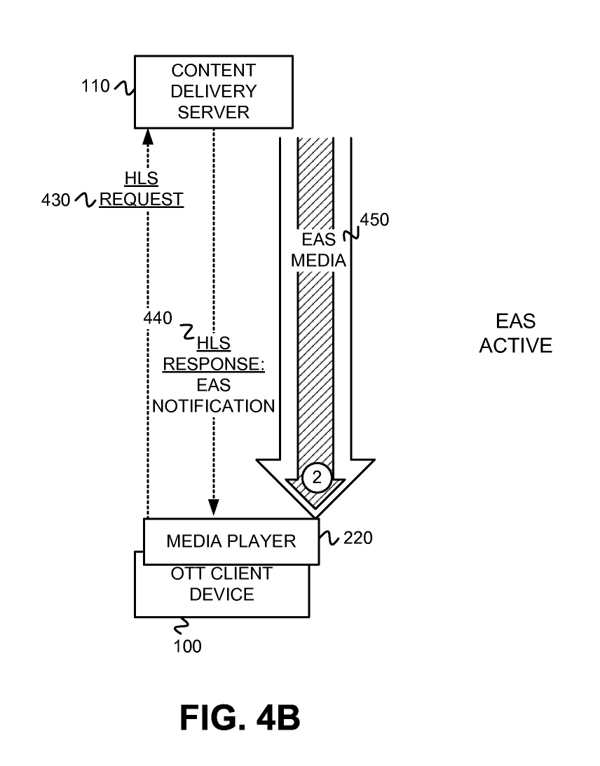

Server(s) 215 may include one or more network devices that may store, at least temporarily, EAS data and/or media that is to be delivered to OTT client devices 100-1 through 100-N at the occurrence of an EAS event (e.g., natural disaster, weather emergency, etc.). Server(s) 215 may receive EAS data and/or media and deliver the EAS data and/or media to content delivery servers 110-1 through 110-M for further delivery to OTT client devices 100-1 through 100-N via an OTT service. Server(s) 215 may deliver EAS notifications to OTT client devices 100-1 through 100-N as described below with respect to the exemplary embodiments of FIGS. 4A-5, 6A-7, 8A-9, and 10A-12.

OTT client devices 100-1 through 100-N may each execute a respective media player 220-1 through 220-N. Media players 220-1 through 220-N may “play” media and/or other data streamed, or delivered by other means, to OTT client devices 100-1 through 100-N.

Network 210 may include one or more networks including, for example, a wireless public land mobile network (PLMN) (e.g., a Code Division Multiple Access (CDMA) 2000 PLMN, a Global System for Mobile Communications (GSM) PLMN, a Long Term Evolution (LTE) PLMN and/or other types of PLMNs), a telecommunications network (e.g., Public Switched Telephone Networks (PSTNs)), a local area network (LAN), a wide area network (WAN), a metropolitan area network (MAN), an intranet, the Internet, or a cable network (e.g., an optical cable network). Network 225 may enable VCMS 202, content nodes 205-1 through 205-P, content delivery servers 110-1 through 110-M, OTT client devices 100-1 through 100-N, and server(s) 215 to communicate with one another, and to deliver media from one node to a next node (e.g., from content delivery server 110 to OTT client device 100).

FIG. 2B depicts further details of media delivery via the various nodes of media delivery network 210. As shown in FIG. 2B, VCMS 205 may deliver media and instructions to content node 205. Content node 205 may distribute the media to multiple content delivery servers 110-1 through 110-M via network 200. In turn, content delivery servers 110-1 through 110-M may distribute the media to OTT client devices 100-1 through 100-N via network 210. For example, as depicted in FIG. 2B, content delivery server 110-1 may deliver the media to each of OTT client devices 100-1 through 100-N, and content delivery server 110-M may deliver the media to each of OTT client devices 100-1 through 100-N. The delivery of media from content node 215 to content delivery servers 110-1 through 100-M, and from content delivery servers 110-1 through 110-M to OTT client devices 110-1 through 100-N may occur via one or more intervening nodes (not shown) of network 210, which may receive and forward data units associated with the delivered media.

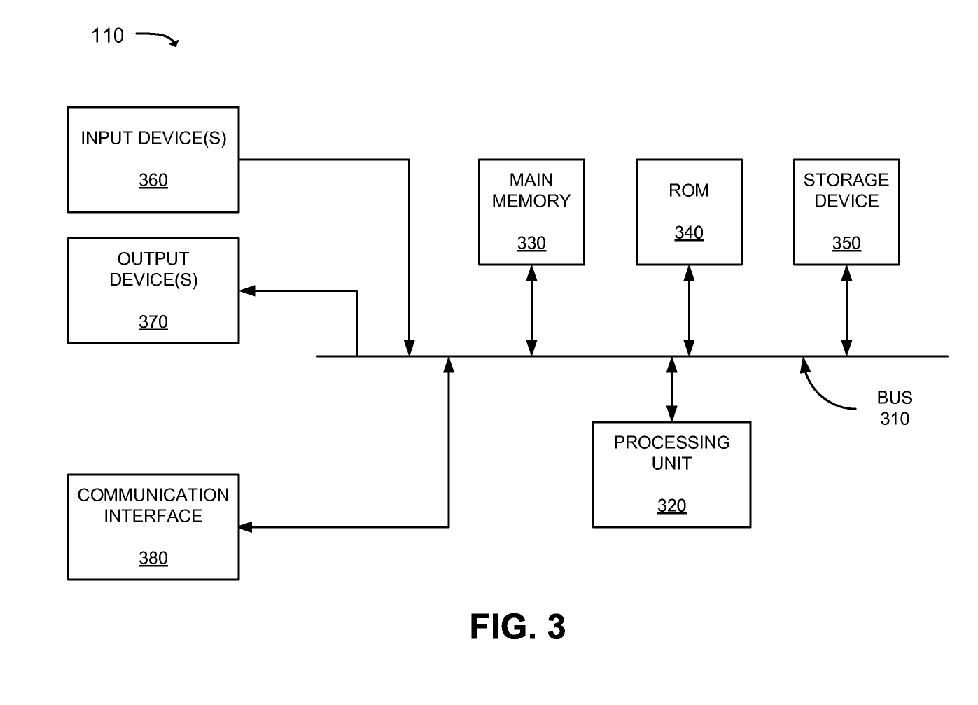

FIG. 3 is a diagram that depicts exemplary components of content delivery server 110. Content node 205, VCMS 202, server 215 and OTT client device 100 may be similarly configured. Content delivery server 110 may include a bus 310, a processing unit 320, a main memory 330, a read only memory (ROM) 340, a storage device 350, an input device(s) 360, an output device(s) 370, and a communication interface(s) 380. Bus 310 may include a path that permits communication among the components of content delivery server 110.

Processing unit 320 may include one or more processors or microprocessors, or processing logic, which may interpret and execute instructions. Main memory 330 may include a random access memory (RAM) or another type of dynamic storage device that may store information and instructions for execution by processing unit 320. ROM 340 may include a ROM device or another type of static storage device that may store static information and instructions for use by processing unit 320. Storage device 350 may include a magnetic and/or optical recording medium. Main memory 330, ROM 340 and storage device 350 may each be referred to herein as a “computer-readable medium.”

Input device 360 may include one or more mechanisms that permit an operator to input information to content delivery server 110, such as, for example, a keypad or a keyboard, a display with a touch sensitive panel, voice recognition and/or biometric mechanisms, etc. Output device 370 may include one or more mechanisms that output information to the operator, including a display, a speaker, etc. Input device 360 and output device 370 may, in some implementations, be implemented as a user interface (UI) that displays UI information and which receives user input via the UI. Communication interface(s) 380 may include a transceiver that enables content delivery server 110 to communicate with other devices and/or systems. For example, communication interface(s) 380 may include wired or wireless transceivers for communicating via media delivery network 210.

The configuration of components of content delivery server 110 illustrated in FIG. 3 is for illustrative purposes. Other configurations may be implemented. Therefore, content delivery server 110 may include additional, fewer and/or different components than those depicted in FIG. 3.

FIGS. 4A and 4B depict an exemplary embodiment in which OTT client device 100 is notified of EAS media delivery via a notification inserted into a HLS response message returned to OTT client device 100 in response to an HLS request message. FIG. 4A depicts the streaming of media from content delivery server 110 to OTT client device 100 when EAS is inactive. Media player 220 of OTT client device 100, to request the delivery of streaming media, sends a HLS request 400 to content delivery server 110. In response to receipt of HLS request 400, content delivery server 110 may return a HLS response 410 to OTT client device 100, with HLS response 410 including a playlist file. The playlist file may include, for example, an ordered list of media Uniform Resource Identifiers (URIs) and informational tags, with each media URI referring to a media file which is a segment of a single continuous stream of media, or referring to another playlist file. The playlist file may be organized as set forth in the Internet Engineering Task Force (IETF) draft entitled “HTTP Live Streaming” dated Nov. 19, 2010. Media player 220 may, based on the ordered list of media URIs contained in the received playlist file, request the delivery of a portion of the streaming media that includes a segment of a single stream of media. Content delivery server 110 may deliver the requested portion of streaming media 420 to media player 220 at OTT client device 100.

FIG. 4B depicts the streaming of EAS media from content delivery server 110 to OTT client device 100 when EAS is active. Server(s) 215 may notify content delivery server 110 that EAS is active by delivering EAS media to content delivery server 110. Media player 220 of OTT client device 100 sends a HLS request 430 to content delivery server 110 to request streaming media. In response to receipt of HLS request 430, content delivery server 110 may return a HLS response 440 to OTT client device 100, with HLS response 440 including a playlist file and an EAS notification inserted into HLS response 440 as a custom response code. The EAS notification serves to notify media player 220 at OTT client device 100 that EAS media is ready for delivery to OTT client device 100. Media player 220 may, upon receipt of HLS response 440 with the EAS notification, suspend playback of streaming media 420, dismiss or disable the user interface such that user input is prevented or inhibited, and request delivery of the EAS media. Content delivery server 110 may inject the requested EAS media 450 into a same stream as streaming media 420 being delivered to media player 220 at OTT client device 100. Thus, streaming media 420 from content delivery server 110 is interrupted by the injection of EAS media 450 into the same stream as streaming media 420. When playback of streaming EAS media 450 has finished, media player 220 may resume playback of streaming media 420 using the ordered list of URIs contained in the most recently received playlist file.

In the exemplary embodiment of FIGS. 4A and 4B, in a situation where OTT client device 100 is not receiving streaming media from content delivery server 110 when EAS becomes active, but media is currently being viewed on device 100's media player 220, content delivery server 110 may stream a portion of dummy media (e.g., 1 pixel size of media) to OTT client device 100 such that the media currently being viewed on device 100 may be overridden, an EAS notification (in an HLS message) can then be sent to OTT client device 100, and the EAS media may be streamed to media player 220 of OTT client device 100.

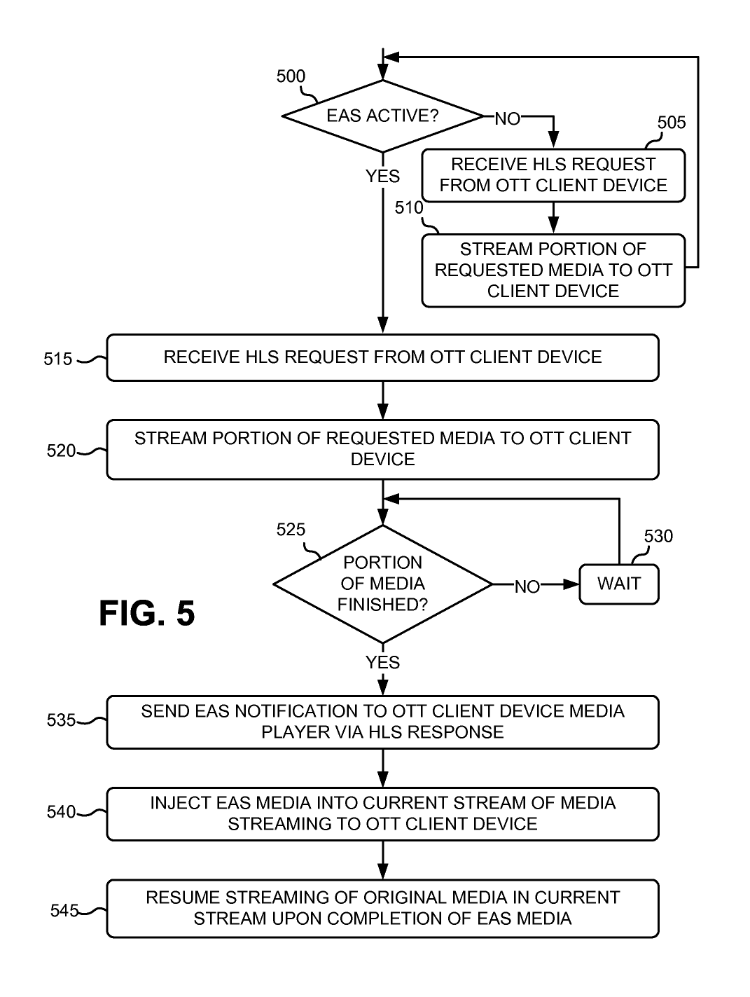

FIG. 5 is a flow diagram of an exemplary process associated with the embodiment of FIGS. 4A and 4B in which OTT client device 100 is notified of EAS media delivery via a notification inserted into a HLS response message returned to the OTT client device in response to an HLS request message. The exemplary process of FIG. 5 may be implemented by content delivery server 110.

The exemplary process may include determining whether EAS is active (block 500). Content delivery server 110 may determine whether EAS is active or inactive based on receiving an EAS notification or EAS media from another network node, such as, for example, server 215. Server 215 may send a notification of an EAS event to content delivery server 110, including EAS media to be delivered to OTT client devices 100-1 through 100-N.

If EAS is inactive (NO-block 500), then content delivery server 110 may receive a HLS request from OTT client device 100 (block 505), and may stream a portion of the requested media to OTT client device 100 (block 510). Subsequent to block 510, the exemplary process may return to block 500 with a determination of whether EAS has become active.

If EAS is active (YES-block 500), then content delivery server 110 may receive a HLS request from OTT client device 110 (block 515), and may then stream a portion of the requested media to OTT client device 110 (block 520). Content delivery server 110 may determine if the portion of streamed media has finished (block 525). If not (NO-block 525), then content delivery server 110 may wait (block 530) until the portion of streamed media finishes (YES-block 525). When the portion of the media is finished streaming to OTT client device 100 (YES-block 525), then content delivery server 110 may send an EAS notification to media player 220 of OTT client device 100 (block 535). Content delivery server 110 then injects the EAS media into the current stream of media streaming to OTT client device 100 (block 540). Upon completion of delivery of the EAS media to OTT client device 100, content delivery server 110 may resume the streaming of the original media in the current stream (block 545).

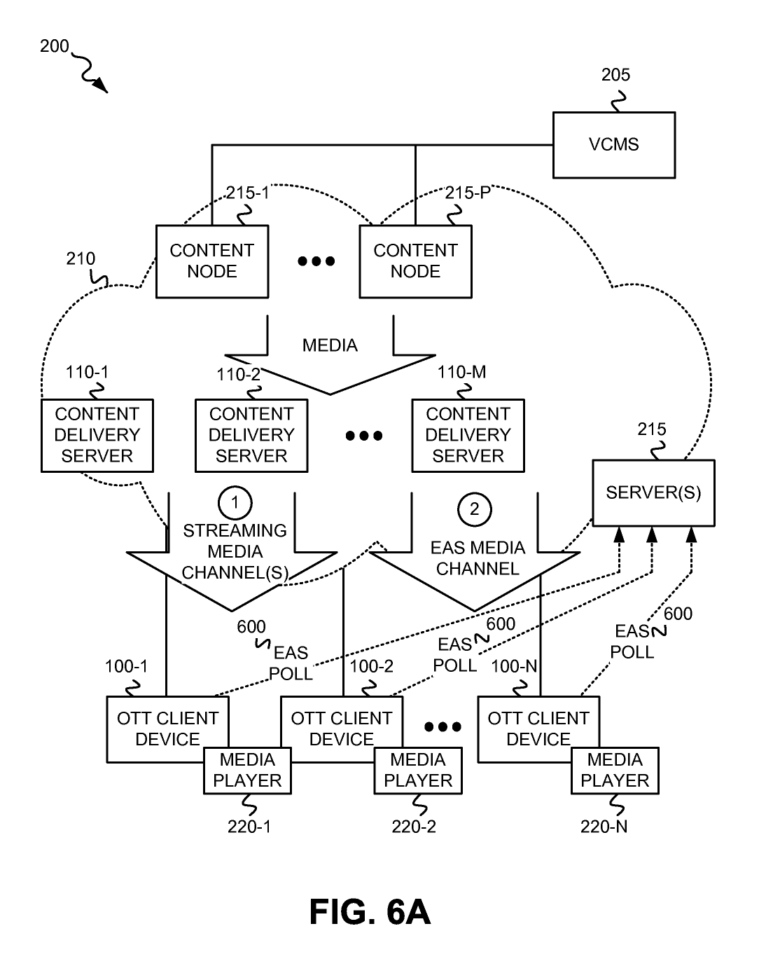

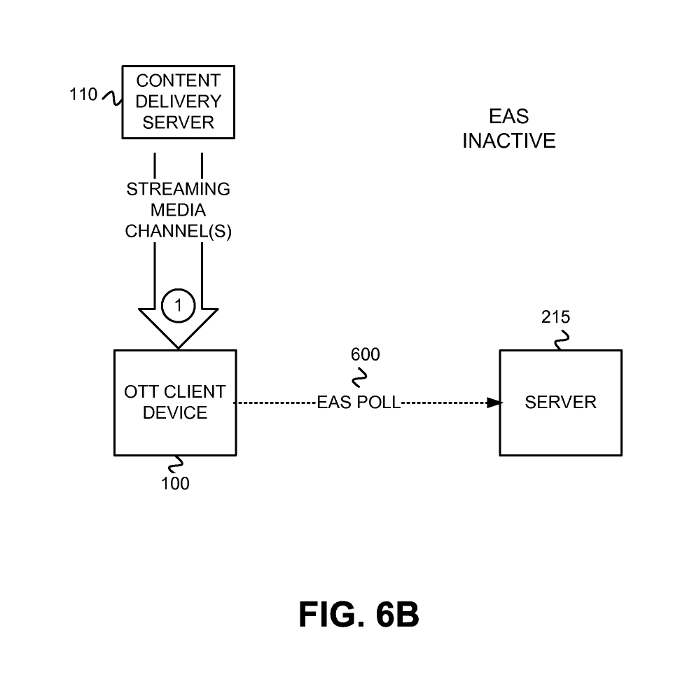

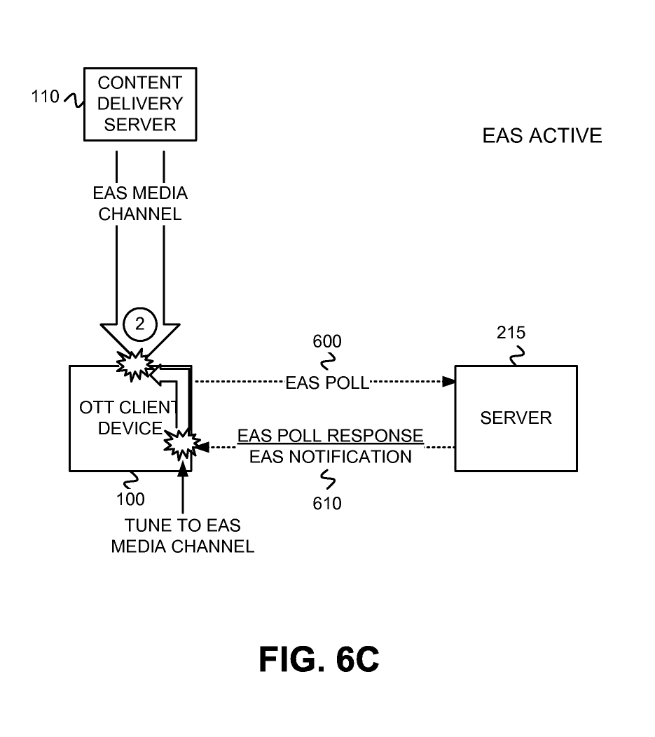

FIGS. 6A, 6B and 6B depict another exemplary embodiment in which OTT client devices 100-1 through 100-N poll EAS server 215 to determine whether EAS has become active. As shown in FIG. 6A, each of OTT client devices 100-1 through 100-N separately polls server 215 with an EAS poll message 600 to determine whether EAS has become active and server 215 has received EAS media associated with an EAS event. During the polling of server 215, OTT client devices 100-1 through 100-N may be receiving streaming media from content delivery servers 110-1 through 110-M via streaming media channels (identified with a “1” within a circle). After receiving an EAS notification in response to an EAS poll 600, OTT client devices 100-1 through 100-N may tune to an EAS media channel (identified with a “2” within a circle) to receive EAS media.

FIG. 6B depicts the polling of server 215 by OTT client device 100 when EAS is inactive. As shown in FIG. 6B, content delivery server 110 may stream media to OTT client device via a streaming media channel (identified with a “1” within a circle) while OTT client device 100 polls server 215 with an EAS poll message 600. If EAS is inactive, then server 215 may return no poll response. In an alternative embodiment, if EAS is inactive, then server 215 may return a response message (not shown in FIG. 6B) to OTT client device 100 that explicitly indicates that EAS is inactive.

FIG. 6C depicts the polling of server 215 by OTT client device 100 when EAS is active. Subsequent to OTT client device 100 sending an EAS poll message 600 to server 215, server 215 may return an EAS poll response message 610 that includes an EAS notification indicating that EAS is active. The EAS notification may additionally identify the EAS media channel over which the EAS media may be streamed to OTT client device 100. OTT client device 100 may, based on the received EAS notification, tune to the EAS media channel (identified with a “2” within a circle), and then receive the EAS media from content delivery server 110.

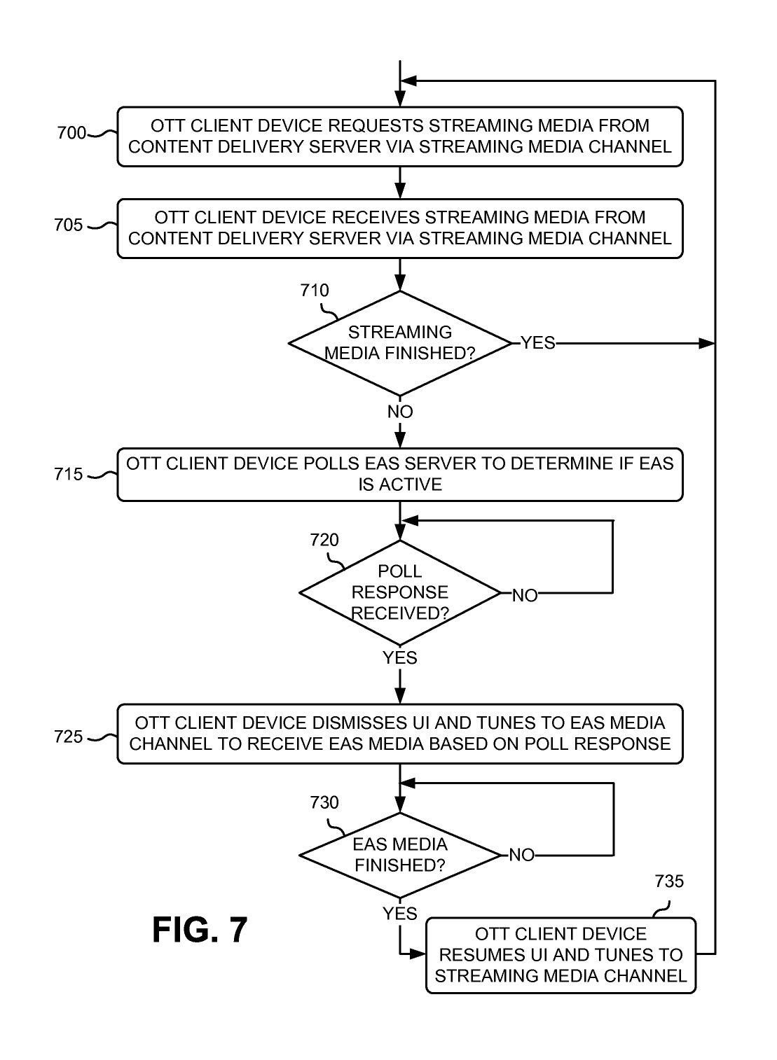

FIG. 7 is a flow diagram of an exemplary process associated with the exemplary embodiment of FIGS. 6A, 6B and 6C in which OTT client devices 100-1 through 100-N poll EAS server 215 to check whether EAS has become active. The exemplary process of FIG. 7 may be implemented by OTT client device 100.

The exemplary process may include OTT client device 100 requesting the delivery of streaming media from content delivery server 110 via a streaming media channel (block 700). OTT client device 100 may send a message to content delivery server 110 requesting the streaming of media. For example, if HLS if used for streaming media from content delivery server 110 to OTT client device 100, then OTT client device 100 may extract a media URI from a playlist file, and may request the media file associated with the media URI from content delivery server 110.

OTT client device 100 may receive streaming media from content delivery server 110 via the streaming media channel (block 705). For example, content delivery server 110 may deliver the media file, in a sequence of media files, requested by OTT client device 100 with a media URI. As shown in FIG. 6B, content delivery server 110 may deliver the media to OTT client device 100 via the streaming media channel. OTT client device 100 may determine if the streaming media has finished (block 710). If so (YES-block 710), then the exemplary process may return to block 700 with a subsequent request for streaming media. If the streaming media is not finished (NO-block 710), then OTT client device 100 may poll EAS server 215 to determine whether EAS is active (block 715). For example, FIGS. 6B and 6C depict OTT client device 100 sending a poll message 600 to server 215 to identify whether EAS is, or is not, active.

OTT client device 100 may determine whether a poll response has been received from EAS server 215 (block 720). If a poll response is received (YES-block 720), then OTT client device 100 may dismiss or disable its user interface (UI) and may then, based on the poll response, tune to the EAS media channel to receive EAS media (block 725). FIG. 6C depicts server 215 returning an EAS poll response message 610 to OTT client device 100 in response to EAS poll message 600. EAS poll response message 610 may include an EAS notification that notifies OTT client device 100 that EAS is active, and which further identifies the EAS media channel to which OTT client device 100 should tune to receive the EAS media delivered from content delivery server 110. Upon receipt of the EAS notification in EAS poll response message 610, OTT client device 100 may automatically tune to the EAS media channel to receive the EAS media from content delivery server 110. When OTT client device 100 dismisses or disables its UI, it may remove the UI from device 100's display, and may prevent any (or most) user input to the user interface until the EAS media is finished.

OTT client device 100 may determine if the EAS media is finished (block 730). If the EAS media has finished, then OTT client device 100 may resume the UI and may tune to the streaming media channel (block 735). After re-tuning to the streaming media channel, the exemplary process may return to block 700 with another request for streaming media to content delivery server 110 from OTT client device 100.

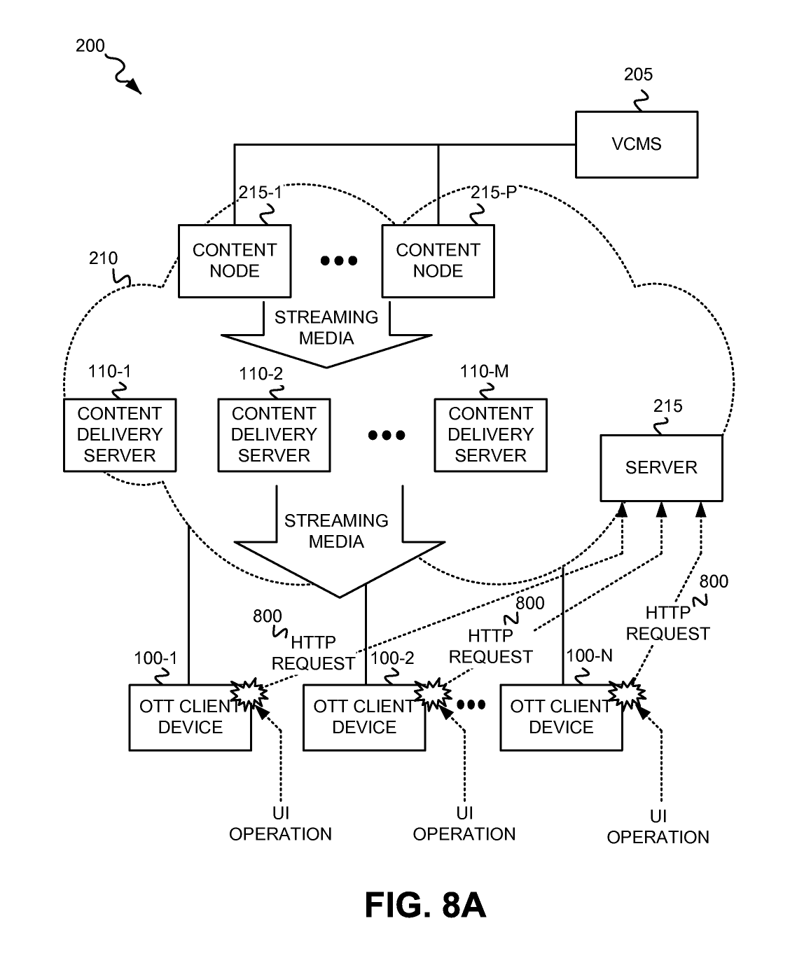

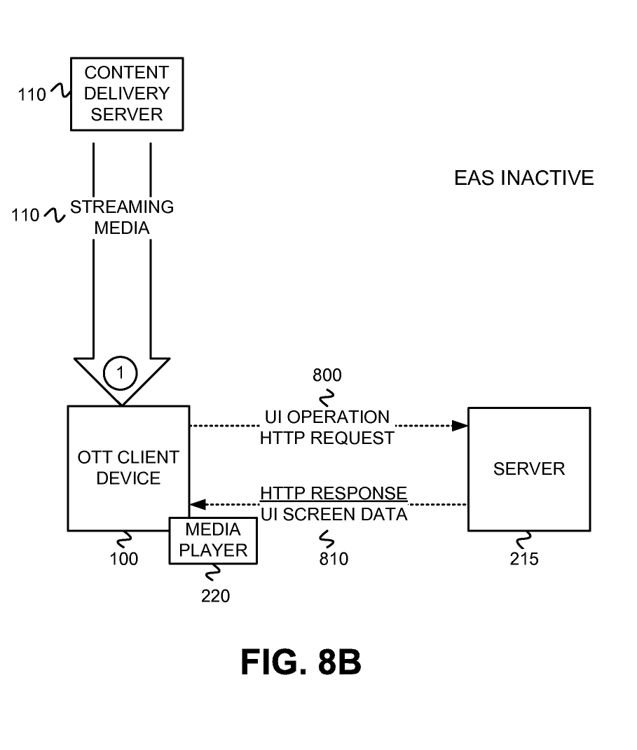

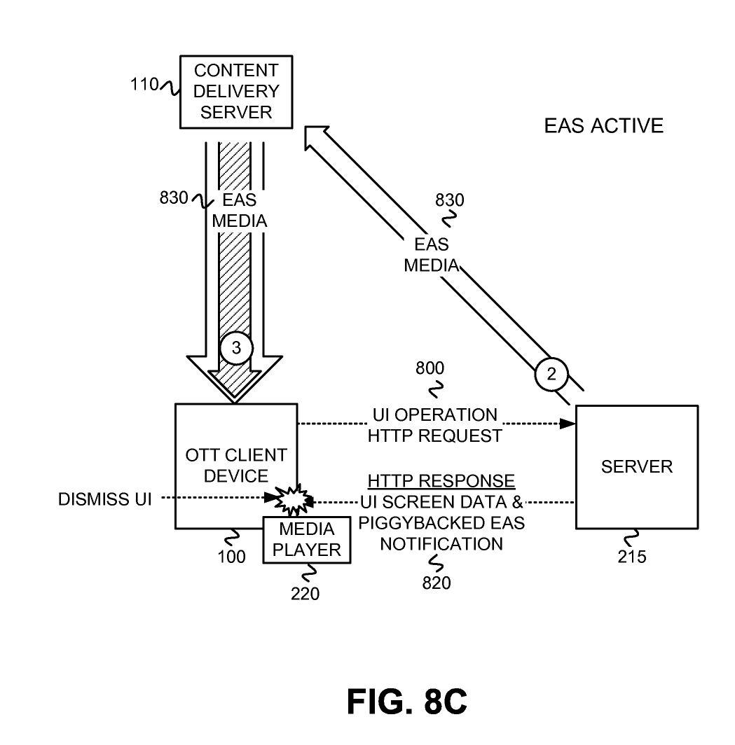

FIGS. 8A, 8B and 8C depict a further exemplary embodiment in which OTT client devices 100-1 through 100-N receive EAS notifications in HTTP response messages received from server 215 in response to HTTP request messages that request a resource (e.g., screen images, etc.) from server 215. As shown in FIG. 8A, each of OTT client devices 100-1 through 100-N may, upon the execution of a UI operation, send an HTTP request message 800 to server 215 to request a resource, such as, for example, one or more images for display in the UI. In this exemplary embodiment, each UI operation at OTT client device 100 may require a network call to server 215 to obtain an appropriate resource (e.g., an image(s)) that is associated with the UI operation for display on the UI screen.

FIG. 8B depicts a circumstance where EAS is inactive and OTT client device 100 requests UI screen data from server 215. As shown in FIG. 8B, OTT client device 100 may send a HTTP request message 800, associated with a UI operation, to server 215. Upon receipt of HTTP request message 800, server 215 may, upon also determining that EAS is inactive, return a HTTP response message 810, that includes UI screen data (e.g., images and/or graphics associated with the operation), to OTT client device 100 for display in the UI.

FIG. 8C depicts a circumstance where EAS is active and OTT client device 100 requests UI screen data from server 215 upon the execution of a UI operation at OTT client device 100. As shown in FIG. 8C, OTT client device 100 may send a HTTP request message 800, associated with a UI operation, to server 215. Upon receipt of HTTP request message 800, server 215 may, upon also determining that EAS is active, return a HTTP response message 820 to OTT client device 100 that includes UI screen data (e.g., images and/or graphics associated with the UI operation) and a piggybacked EAS notification. Server 215 may also deliver EAS media 830 to content delivery server 110 (identified with a “2” within a circle). Upon receipt of HTTP response message 820, and extraction of the EAS notification from message 820, OTT client device 100 may receive EAS media 830 (identified with a “3” within a circle) within a same stream as the previously received streaming media from content delivery server 110. Upon receipt of EAS media 830, OTT client device 100 may dismiss or disable the UI, and prevent and/or inhibit user interaction with the UI, until playback of EAS media 830 has finished.

In the exemplary embodiment of FIGS. 8A, 8B and 8C, in a situation where OTT client device 100 is not receiving streaming media from content delivery server 110 when EAS becomes active, but media is currently being viewed on device 100's media player 220, content delivery server 110 may stream a portion of dummy media (e.g., 1 pixel size of media) to OTT client device 100 such that the media currently being viewed on device 100 may be overridden, an EAS notification (in an HTTP message) can be sent to OTT client device 100, and the EAS media may be streamed to media player 220 of OTT client device 100.

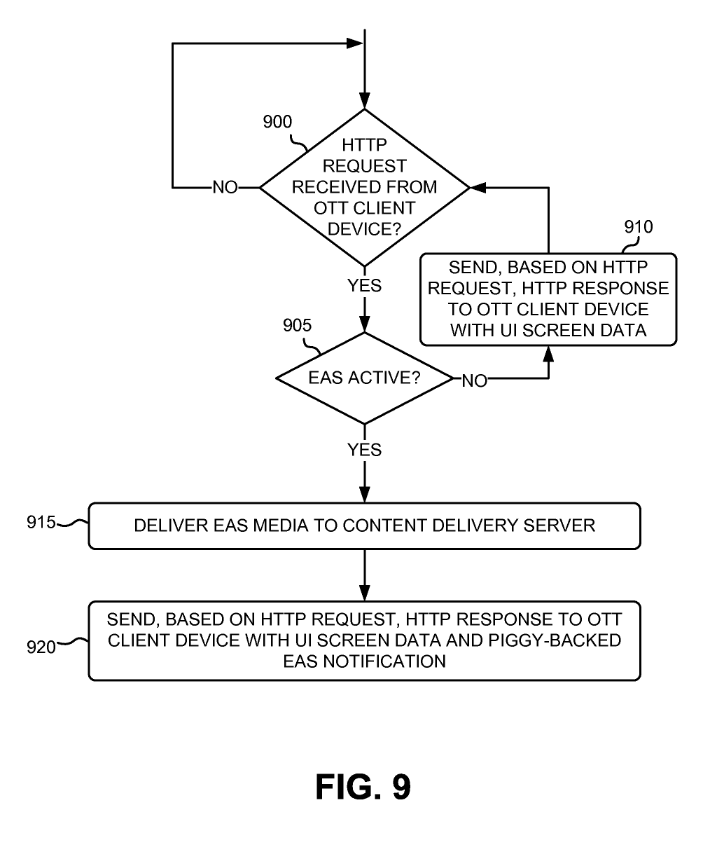

FIG. 9 is a flow diagram of an exemplary process associated with the exemplary embodiment of FIGS. 8A, 8B and 8C in which OTT client devices 100-1 through 100-N receive EAS notifications in HTTP response messages received from server 215 in response to HTTP request messages that request a resource (e.g., screen images, etc.) from server 215. The exemplary process of FIG. 9 may be implemented by server 215, where server 215 may include a data center server.

The exemplary process may include server 215 determining whether a HTTP request, requesting UI screen data associated with a UI operation, has been received from OTT client device 100 (block 900). FIG. 8B or 8C depict OTT client device 100 sending a HTTP request message 800 to server 215 to request UI screen data (e.g., images and/or graphics associated with each UI operation). If a HTTP request has been received from OTT client device 100 (YES-block 900), then server 215 may determine if EAS is active (block 905). Server 215 may have previously been notified of an occurrence of an EAS event and may have been supplied with EAS media associated with the EAS event. If EAS is determined to be not active (NO-block 905), then server 215 may send, based on the HTTP request, a HTTP response message to OTT client device 100 that includes the requested UI screen data (block 910), and the exemplary process may return to block 900. Referring to FIG. 8B, server 215 may return HTTP response message 810 to OTT client device 100, wherein message 810 includes the requested UI screen data associated with UI operation to be executed at OTT client device 100.

If EAS is determined to be active (YES-block 905), then server 215 may deliver EAS media to content delivery server 110 (block 915). FIG. 8C depicts server 215 sending EAS media 830 to content deliver server 110 for subsequent delivery to OTT client device 100. Server 215 may then send, based on the received HTTP request, a HTTP response message to OTT client device 100 with UI screen data and a piggy-backed EAS notification (block 920). Referring again to FIG. 8C, server 215 sends HTTP response message 820 to OTT client device 100, wherein message 820 includes UI screen data and a piggybacked EAS notification notifying OTT client device 100 of the EAS event. Upon receipt of HTTP response message 820, and extraction of the EAS notification from message 820, OTT client device 100 may receive EAS media 830 (identified with a “3” within a circle) within a same stream as previously received streaming media from content delivery server 110. Upon receipt of EAS media 830, OTT client device 100 may dismiss or disable the UI, preventing and/or inhibiting user interaction with the UI, until playback of EAS media 830 has finished.

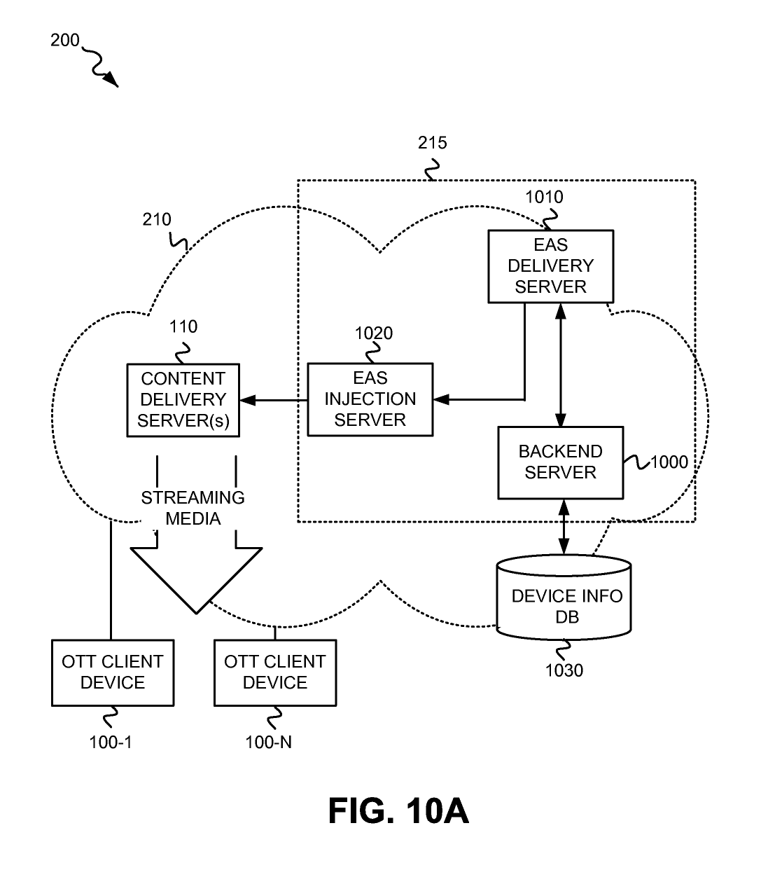

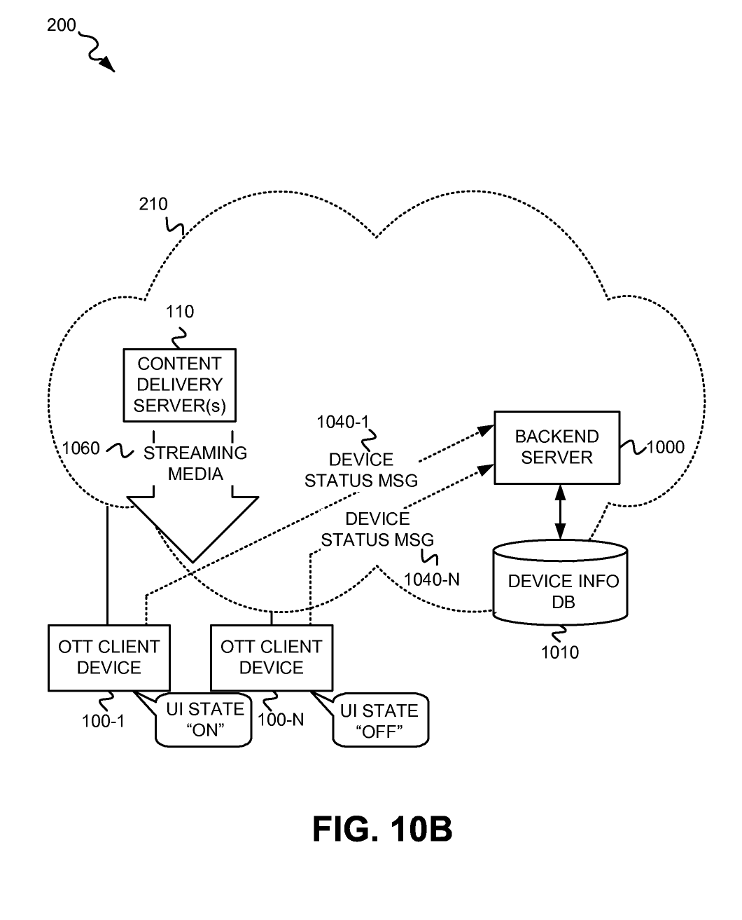

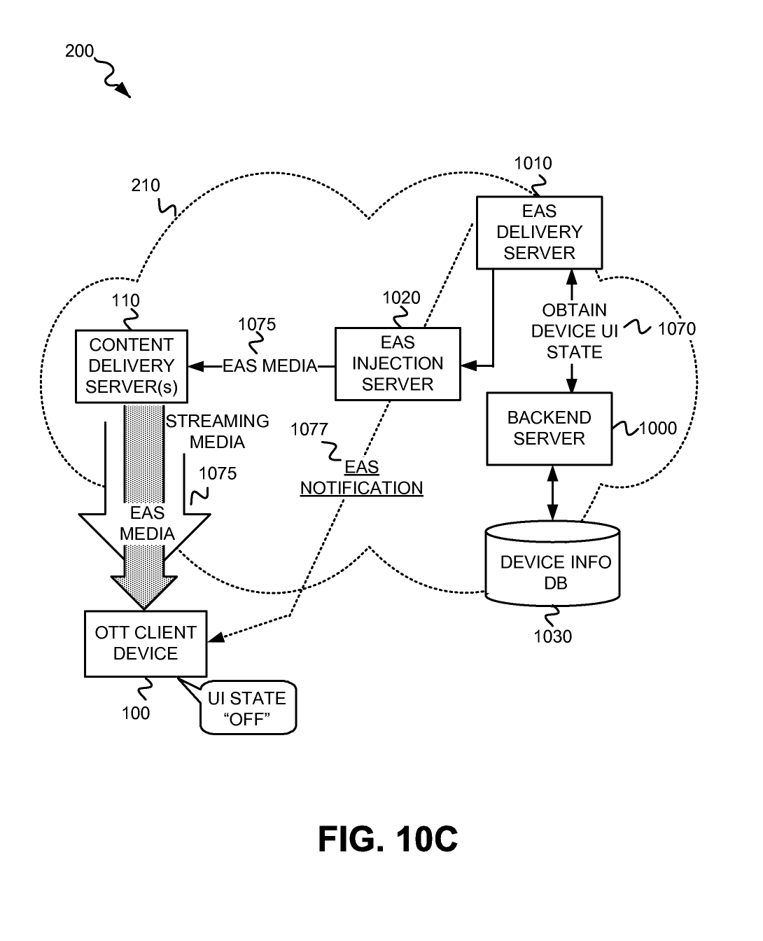

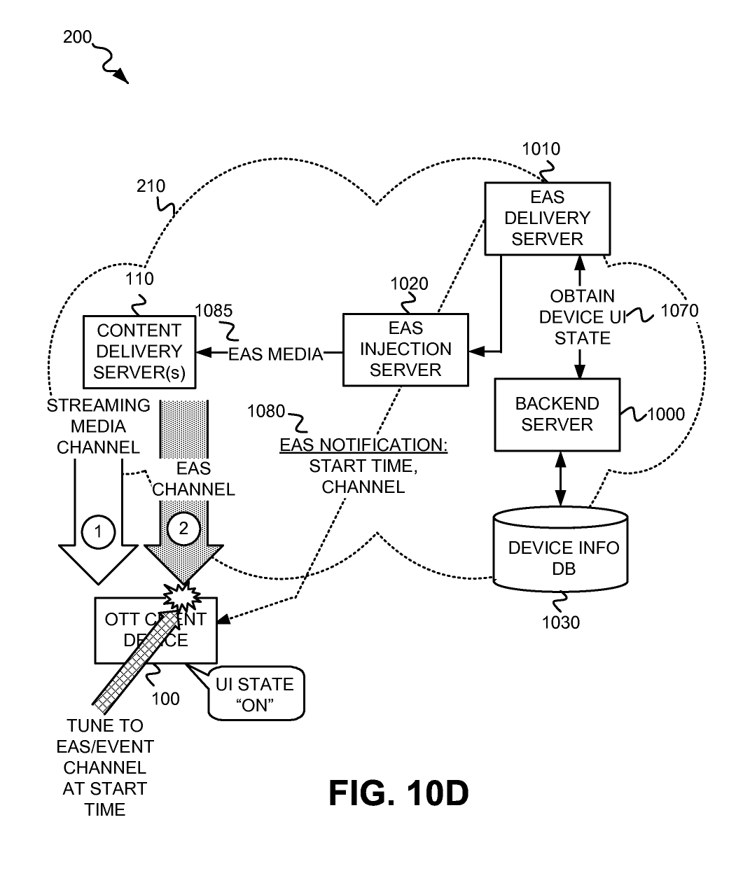

FIGS. 10A-10D depict an additional exemplary embodiment in which OTT client devices 100-1 through 100-N each report whether or not they are currently receiving streaming media from content delivery server 110, and EAS media is delivered to OTT client devices 100-1 through 100-N either in a same stream as the currently streaming media, or in a different stream on a different channel, based on each device's report. As shown in FIG. 10A, server(s) 215 may include multiple servers, including backend server 1000, EAS delivery server 1010, and EAS injection server 1020. As further shown in FIG. 10A, backend server 1000 may store data in, and retrieve data from, device information database (DB) 1030. The operations performed by servers 1000, 1010, and 1020 are described below with respect to FIGS. 10B-10D.

FIG. 10B depicts OTT client devices 100-1 through 100-N determining the state of their respective UIs, and sending device status messages 1040-1 through 1040-N to backend server 1000 to notify backend server 1000 of the devices' UI states. If OTT client device 100 is tuned to, and is currently receiving, streaming media from content delivery server 110, then OTT client device 100's UI state is considered to be “off” If OTT client device 100 is not tuned to, or is not currently receiving, streaming media from content delivery server 110, then OTT client device 100's UI state is considered to be “on.” Upon receipt of device status messages 1040-1 through 1040-N, backend server 1000 may extract the UI state from the messages, and store each device's UI state in device information DB 1010.

FIG. 10C depicts a circumstance where OTT client device 100's UI state is “off,” and EAS is active. As shown in FIG. 10C, EAS delivery server 1010 obtains 1070 OTT client device 100's UI state from device information DB 1030 via backend server 1000. After identifying that OTT client device 100's UI state is “off,” indicating that OTT client device 100 is currently tuned to, and is receiving streaming media from content delivery server 110, EAS delivery server 1010 sends an EAS notification message 1077 to OTT client device 100 notifying device 100 that EAS is active and EAS media delivery is pending. Based on receipt of EAS notification message 1077, OTT client device 100 dismisses the UI and prevents UI interactions until completion of the EAS media delivery. EAS delivery server 1010 further instructs EAS injection server 1020 to inject the EAS media 1075 into the same stream as the streaming media previously being delivered from content delivery server 110 to OTT client device 100.

FIG. 10D depicts another circumstance where OTT client device 100's UI state is “on,” and EAS is active. As shown in FIG. 10D, EAS delivery server 1010 obtains 1070 OTT client device 100's UI state from device information DB 1030 via backend server 1000. After identifying that OTT client device 100's UI state is “on,” indicating that OTT client device 100 is not currently tuned to, nor is receiving streaming media from content delivery server 110, EAS delivery server 1010 sends an EAS notification message 1080 to OTT client device 100 to identify to OTT client device 100 the EAS media start time and EAS media delivery channel. Upon receipt of EAS notification 1080, dismisses or disables the UI and prevents UI interactions until completion of the EAS media delivery. OTT client device 100 further automatically re-tunes to the EAS channel at the EAS media start time identified in the EAS notification 1080 to receive the EAS media 1085 via a different EAS media channel (identified with a “2” within a circle) than the channel (identified with a “1’ within a circle) in which the streaming media was previously received.

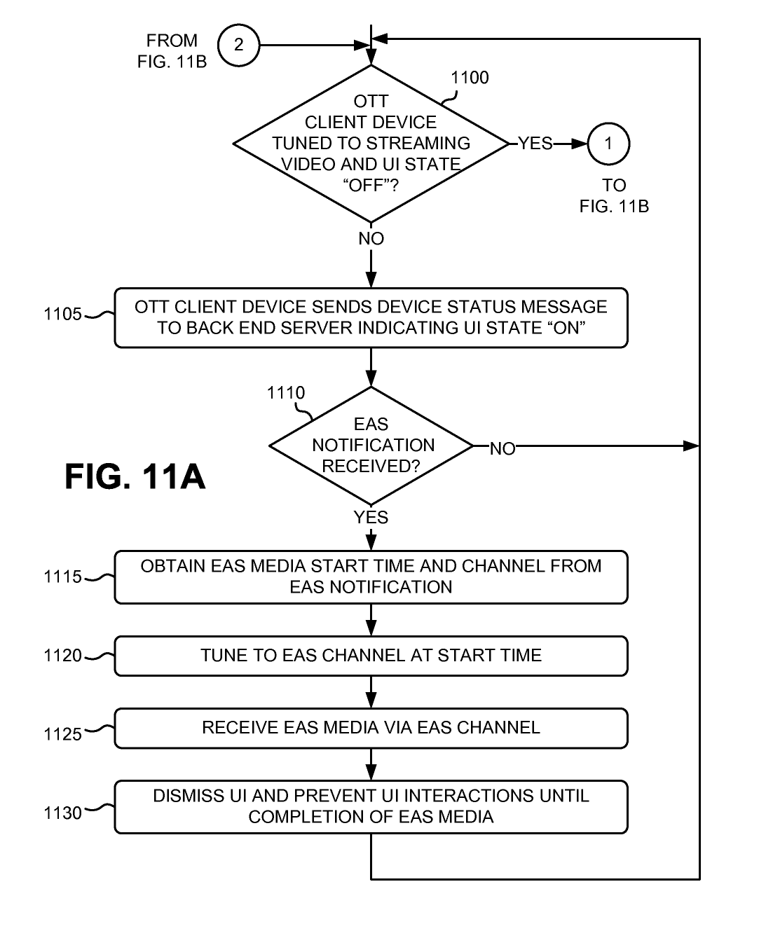

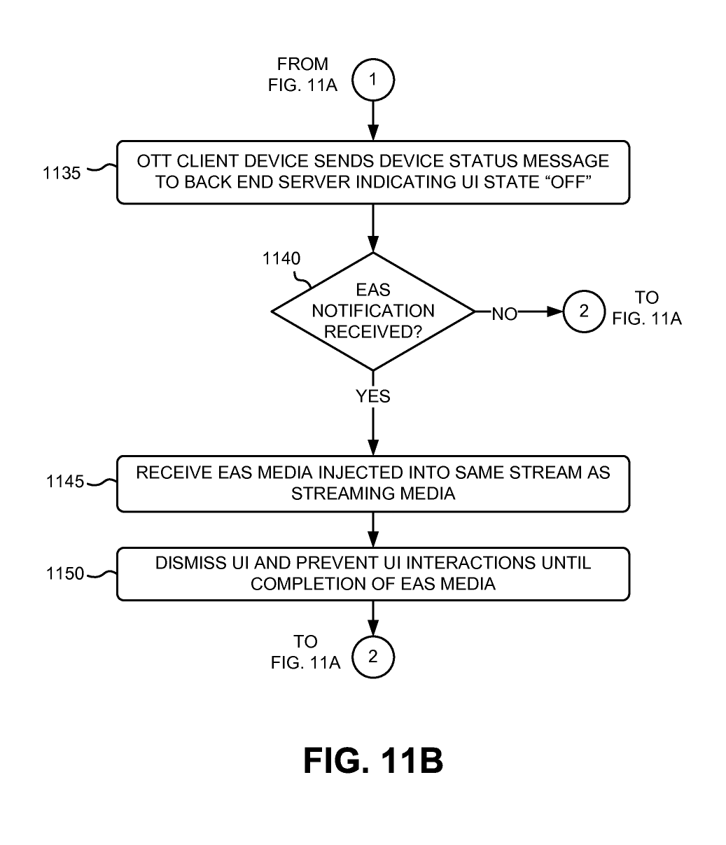

FIGS. 11A and 11B are flow diagrams of an exemplary process associated with the exemplary embodiment of FIGS. 10A-10D in which EAS media is delivered to OTT client devices 100-1 through 100-N, either in a same stream as currently streaming media or in a different stream on a different channel, based on UI status report messages sent by each of devices 100-1 through 100-N. The exemplary process of FIGS. 11A and 11B may be implemented by OTT client device 100. As described with respect to FIGS. 11A and 11B, a UI state of an OTT client device 100 is “off” when device 100 is tuned to, and is currently receiving, streaming media from content delivery server 110, and a UI state of OTT client device 100 is “on” when device 100 is not tuned to, or receiving, streaming media from content delivery server 110.

The exemplary process may include determining if OTT client device 100 is tuned to streaming video and OTT client device 100's UI state is “off” (block 1100). For example, as shown in FIG. 10B, OTT client device 100-N may be receiving streaming media 1060 and, therefore, OTT client device 100-N's UI state would be considered to be “off.” If OTT client device 100's UI state is “on” and not “off” (NO-block 1100), then OTT client device 100 may send a device status message to backend server 1000 indicating that OTT client device 100's UI state is “on” (block 1105). FIG. 10B depicts OTT client device 100-1 sending a device status message 1040-1 to backend server 1000 to notify server 1000 that device 100-N's UI state is “on.” Upon receiving the device status message, backend server 1000 may store the device status in device information DB 1010. OTT client device 100 may determine if an EAS notification was received from EAS delivery server 1010 (block 1110). EAS delivery server 1010 may send an EAS notification to OTT client device 100 when EAS is active, and OTT client device 100's UI state is “on.”

If an EAS notification was not received at OTT client device 100 (NO-block 1110), then the exemplary process may return to block 1100. If an EAS notification was received at OTT client device 100 from EAS delivery server 1010 (YES-block 1110), then OTT client device 100 may obtain an EAS start time and EAS media channel from the received EAS notification (block 1115). The EAS start time may include the time at which content delivery server 110 may deliver the EAS media to OTT client device 100. The EAS media channel may include the channel and/or the stream over which the EAS media may be delivered to OTT client device 100 from content delivery server 110. FIG. 10D depicts EAS delivery server 1010 sending an EAS notification message 1080 to OTT client device 100, wherein message 1080 includes an identification of the EAS media start time, and the EAS media channel. OTT client device 100 may tune to the EAS channel at the EAS start time (block 1120) and may receive the EAS media via the EAS channel (block 1125). OTT client device 100 may dismiss or disable the UI and prevent or inhibit UI interactions until completion of the EAS media (block 1130). The exemplary process may return to block 1100 with another determination of the current UI state of OTT client device 100.

Returning to block 1100, if OTT client device 100's UI state is “off” (YES-block 1100), then OTT client device 100 may send a device status message to backend server 1000 indicating that OTT client device 100's UI state is “off” (block 1135). FIG. 10B depicts OTT client device 100-N sending a device status message 1040-N to backend server 1000 to notify server 1000 that device 100-N's UI state is “off.” Upon receiving the device status message, backend server 1000 may store the device status in device information DB 1010.

OTT client device 100 may determine if an EAS notification was received from EAS delivery server 1020 (block 1140). If not (NO-block 1125), then the exemplary process may return to block 1100. If an EAS notification was received at OTT client device 100 from EAS delivery server 1020 (YES-block 1140), then OTT client device 100 may receive EAS media injected into a same stream as the previously received streaming media (block 1145), and may dismiss or disable the UI and prevents or inhibits UI interactions until completion of the EAS media (block 1150). FIG. 10C depicts OTT client device 100 receiving EAS stream 1075 injected into a same stream as the previously received streaming media from content delivery server 110.

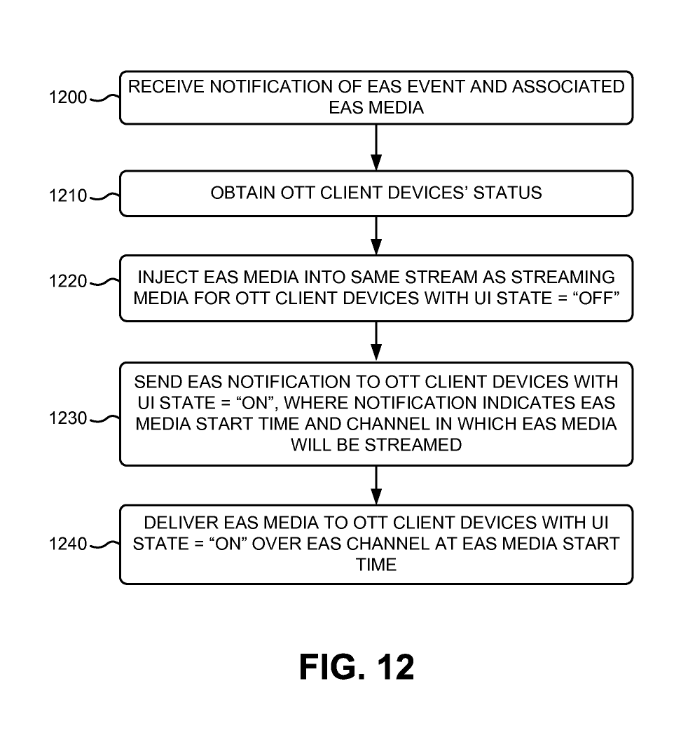

FIG. 12 is a flow diagram of another exemplary process associated with the exemplary embodiment of FIGS. 10A-10D in which EAS media is delivered to OTT client devices 100-1 through 100-N, either in a same stream as currently streaming media or in a different stream on a different channel, based on UI status report messages sent by each of OTT client devices 100-1 through 100-N. The exemplary process of FIG. 12 may be implemented by backend server 1000, EAS delivery server 1010, EAS injection server 102 and/or content delivery server 110.

The exemplary process may include EAS delivery server 1010 receiving a notification of an EAS event, and associated EAS media (block 1200). When an EAS event occurs, a notification of the EAS event, and EAS media associated with the event, may be supplied to EAS delivery server 1010. The notification of the EAS event may also identify a geographic region associated with the EAS event. EAS delivery server 1010 may obtain the status of OTT client devices 100-1 through 100-N (block 1210). EAS delivery server 1010 may obtain the status of OTT client devices 100-1 through 100-N by requesting the UI states of the OTT client devices from device information DB 1030 via backend server 1000. FIG. 10C depicts EAS delivery server 1010 obtaining the device UI state 1070 from backend server 1000.

EAS injection server 1020 may cause the EAS media to be injected into a same stream as media currently being streamed to the OTT client devices with a UI state of “off” (block 1220). EAS delivery server 110 may deliver the EAS media to EAS injection server 1020, and may instruct EAS injection server 1020 to inject the EAS media into the streams of OTT client devices identified as having a UI state of “off.” EAS injection server 1020 may, in turn, instruct content delivery server 110 to inject the EAS media into the current media streams being delivered by content delivery server 110 to OTT client devices having a UI state of “off.”FIG. 10C depicts content delivery server 110 injecting EAS stream 1075 into media being streamed to OTT client device 100.

EAS delivery server 1010 may send an EAS notification to OTT client devices with a UI state of “on,” where the EAS notification indicates an EAS media start time and a channel in which the EAS media will be streamed (block 1230). FIG. 10D depicts EAS delivery server 1010 sending an EAS notification message 1080 to OTT client device 100, where message 1080 includes the EAS media start time and the EAS media channel.

Content delivery server 110 may deliver the EAS media to the OTT client devices with a UI state of “on” over the EAS channel and at the EAS media start time (block 1240). EAS delivery server 110 may deliver the EAS media to EAS injection server 1020, and may instruct EAS injection server 1020 to deliver the EAS media to content delivery server 110 such that content delivery server 110 may deliver the EAS media to the OTT client devices with a UI state of “on” on the EAS media channel at the EAS media start time identified in the EAS notification. FIG. 10D depicts content delivery server 110 delivering the EAS media over the EAS channel to OTT client device 100.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 5, 7, 9, 11A, 11B and 12, the order of the blocks may be varied in other implementations. Moreover, non-dependent blocks may be performed in parallel.

Implementations have been described herein with respect to providing EAS media and data to OTT client devices when an EAS event occurs. However, media and data may be delivered to OTT client devices based on the occurrence of other types of events that may not include EAS events. Furthermore, implementations have been described herein as involving EAS notifications via an OTT service. However, in other implementations, EAS notifications may be delivered via Internet Protocol TV (IPTV) or other streaming media services, such as, for example, streaming music services.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving first streaming media from a content delivery server at a client device via an OTT network service;
receiving an Emergency Alert System (EAS) notification at the client device;
receiving via the OTT network service and playing, subsequent to the EAS notification, EAS media at the client device; and
disabling a user interface at the client device to prevent user interface interactions until completion of the playing of the EAS media.

2. The method of claim 1, wherein the first streaming media is received via a first stream and a first channel.

3. The method of claim 2, further comprising:
tuning, at the client device, to the first stream and the first channel to receive the EAS media based on the EAS notification.

4. The method of claim 2, further comprising:
tuning, at the client device, to a second stream and a second channel to receive the EAS media based on the EAS notification, wherein the second stream is different than the first stream.

5. The method of claim 1, further comprising:
requesting delivery of the first streaming media via a Hypertext Transfer Protocol (HTTP) Live Streaming (HLS) request; and
wherein receiving the EAS notification comprises:
receiving the EAS notification in an HLS response message at the client device from the content delivery server.

6. The method of claim 1, further comprising:
requesting a resource associated with a user interface operation from a server via a Hypertext Transfer Protocol (HTTP) request message, and
wherein receiving the EAS notification comprises:
receiving a HTTP response message from the server, wherein the EAS notification is included with the HTTP response message

7. The method of claim 6, wherein the HTTP response message includes the resource associated with the user interface operation.

8. The method of claim 7, wherein the resource comprises user interface screen data.

9. The method of claim 1, further comprising:
sending an EAS poll message to a server to determine whether EAS is currently active,
wherein receiving the EAS notification comprises:
receiving, if EAS is currently active, an EAS poll response message from the server, wherein the EAS poll response message includes the EAS notification.

10. The method of claim 1, further comprising:
sending a device status message to a server indicating that the client device is not currently tuned to the first streaming media,
wherein the EAS notification identifies an EAS media start time and an EAS channel; and
wherein receiving the EAS media at the client device comprises:
automatically tuning to the EAS channel at the EAS start time to receive the EAS media from the content delivery server.

11. The method of claim 1, further comprising:
sending a device status message to a server indicating that the client device is currently tuned to the first streaming media,
wherein the EAS notification identifies an EAS media start time and an EAS channel; and
wherein receiving the EAS media at the client device comprises:
receiving the EAS media injected into a same stream as the first streaming media.

12. The method of claim 1, wherein the client device includes a computer, a Personal Digital Assistant (PDA), a cellular telephone, or a Set-Top Box (STB)

13. A device, comprising:
an output device configured to display a user interface;
a communication interface configured to:
receive first streaming media from a content delivery server via an Over-The-Top network service,
receive an Emergency Alert System (EAS) notification, and
receive, subsequent to the EAS notification, EAS media from the content delivery server; and
a processing unit configured to:
play the EAS media via the output device, and
disable the user interface to prevent user interface interactions until completion of the playing of the EAS media.

14. The device of claim 13, wherein the first streaming media is received at the communication interface via a first stream and a first channel.

15. The device of claim 14, wherein the communication interface is further configured to:
tune to the first stream and the first channel to receive the EAS media based on the EAS notification.

16. The device of claim 14, wherein the communication interface is further configured to:
tune to a second stream and a second channel to receive the EAS media based on the EAS notification, wherein the second stream is different than the first stream and the second channel is different from the first channel.

17. The device of claim 13, wherein the processing unit is further configured to:
request delivery of the first streaming media via a Hypertext Transfer Protocol (HTTP) Live Streaming (HLS) request to the content delivery server; and
wherein, when receiving the EAS notification, the communication interface is further configured to:
receive the EAS notification in an HLS response message from the content delivery server.

18. The device of claim 13, wherein the processing unit is further configured to:
request a resource associated with a user interface operation from a server via a Hypertext Transfer Protocol (HTTP) request message, and
wherein, when receiving the EAS notification, the communication interface is further configured to:
receive a HTTP response message from the server, wherein the EAS notification is piggybacked on the HTTP response message

19. The device of claim 18, wherein the HTTP response message includes the resource associated with the user interface operation and wherein the resource comprises user interface screen data.

20. The device of claim 13, wherein the communication interface is further configured to:
send an EAS poll message to a server to determine whether EAS is currently active, and
receive, if EAS is currently active, an EAS poll response message from the server, wherein the EAS poll response message includes the EAS notification.

21. The device of claim 13, wherein the EAS notification identifies an EAS media start time and an EAS channel and wherein the communication interface is further configured to:
send a device status message to a server indicating that the client device is not currently tuned to the first streaming media, and
automatically tune to the EAS channel at the EAS start time to receive the EAS media from the content delivery server.

22. The device of claim 13, wherein the communication interface is further configured to:
send a device status message to a server indicating that the client device is currently tuned to the first streaming media, and
receive the EAS media injected into a same stream as the first streaming media.

23. A method, comprising:
identifying, at a first network device, whether an Emergency Alert System (EAS) is active;
sending an EAS notification to a client device if the EAS is identified as being active, wherein the EAS notification notifies the client device of impending delivery of EAS media to the client device from a content delivery device; and
causing the content delivery device to deliver the EAS media to the client device via an Over-The-Top (OTT) service if the EAS is active.

24. The method of claim 23, wherein the EAS notification is included in at least one of a Hypertext Transfer Protocol (HTTP) Live Streaming (HLS) message sent from the content delivery device to the client device, an EAS polling response message sent from the first network device to the client device, or a Hypertext Transfer Protocol (HTTP) message sent from the first network device to the client device.

25. The method of claim 23, wherein the EAS notification includes an identification of a start time and a channel, wherein the start time includes a time at which the EAS media will be delivered from the content delivery device to the client device and the channel includes the channel over which the EAS media will be delivered from content delivery device to the client device.
